(19) United States
(12) Patent Application Publication
(10) Pub. No.: US 2025/0300280 A1
(43) Pub. Date: Sep. 25, 2025

(54) ELECTROCHEMICAL CELL

(71) Applicant: Lina Energy Ltd., Lancaster (GB)

(72) Inventors: Andreas Karl Backstrom, Lancaster (GB); Richard James Dawson, Lancaster (GB); Kristopher Barr, Lancaster (GB)

(21) Appl. No.: 18/860,158

(22) PCT Filed: Apr. 25, 2023
(86) PCT No.: PCT/GB2023/051091

§ 371 Date: Oct. 25, 2024

(30) Foreign Application Priority Data
Apr. 27, 2022 (GB) 2206106.3

(51) Int. Cl. H01M 50/107; H01M 10/0562; H01M 10/39; H01M 10/44; H01M 50/434

(52) U.S. Cl. CPC H01M 50/107; H01M 10/0562; H01M 10/399; H01M 10/44; H01M 50/434

(57) ABSTRACT

A rechargeable electrochemical cell (10) comprises an anode compartment (14) and a cathode compartment (15), the compartments being enclosed in part by metal plates (11, 12) that define end faces of the cell (10), the two compartments (14, 15) being separated by an impermeable, ion-conducting electrolyte element (13). The cell (10) is a molten sodium/metal chloride cell, and the plate (12) enclosing the cathode compartment defines a slightly concave end face surrounded by a flat rim. The volume change of the cathodic materials as the cell is heated up to its operating temperature are accommodated by flattening of the concave end face, so the overall thickness of the cell (10) does not change.

The present invention relates to an electrochemical cell with a solid ionically-conducting electrolyte/separator, each cell having a metallic case.

A number of different types of electrochemical cell are known that require an elevated temperature to operate. These include cells in which an electrolyte must be at elevated temperature to provide adequate conductivity; and cells in which an electrode must be at elevated temperature for an electrode component to be liquid. One such type of cell is a molten sodium/metal halide rechargeable battery, such as the sodium/nickel chloride cell which may be referred to as a ZEBRA cell (see for example J. L. Sudworth, “The Sodium/Nickel Chloride (ZEBRA) Battery (J. Power Sources 100 (2001) 149-163). A sodium/nickel chloride cell incorporates a liquid sodium negative electrode separated from a positive electrode by a solid electrolyte which conducts sodium ions. The solid electrolyte may for example consist of beta alumina. The positive electrode includes nickel, nickel chloride and sodium tetrachloroaluminate which is liquid during use and acts as a secondary electrolyte to allow transport of sodium ions from the nickel chloride to the solid electrolyte. The positive electrode also incorporates aluminium powder. Partial replacement of the nickel with other transition metals such as iron can result in additional discharge voltage levels. The cell operates at a temperature which is typically below 350° C., but must be above the melting point of the sodium tetrachloroaluminate, which is 157° C., and the operating temperature is typically between 270° and 300° C. During discharge the normal reactions are as follows:

Cathode(positive electrode): NiCl₂+2Na⁺+2e⁻→Ni+2NaCl

Anode(negative electrode): Na→Na⁺+e⁻

the overall result being that anhydrous nickel chloride (in the cathode) reacts with metallic sodium (in the anode) to produce sodium chloride and nickel metal; and the cell voltage is 2.58 V at 300° C.

A modified type of a ZEBRA cell, that is to say a molten sodium-nickel chloride rechargeable cell, is described in WO 2019/073260. This uses an electrolyte element that comprises a perforated sheet of non-reactive metal, and a non-permeable layer of sodium-ion-conducting ceramic bonded to one face of the perforated sheet. In this electrolyte element the strength can therefore be provided by the metal sheet, and this enables the electrolyte thickness to be significantly reduced as compared to that required in a conventional ZEBRA cell. This results in a cell or a battery that can perform adequately at significantly lower temperatures, for example less than 200° C. Furthermore, a significantly thinner layer of ceramic also significantly reduces stresses induced by heating from ambient, so start-up times from ambient can be just a few minutes. These are both commercially advantageous benefits. The non-permeable layer is bonded to the perforated metal sheet, and this bonding may be by a porous ceramic sub-layer. Such a cell includes a metal case, which may have a peripheral flange.

An alternative form of molten sodium/nickel chloride cell is described in WO 2022/123246 (application PCT/GB2021/053215) in which the electrolyte is again a planar sheet of ceramic that can conduct ions of the alkali metal, and a perforated planar sheet of an inert metal is immediately adjacent to the sheet of ceramic and in contact with the sheet of ceramic over substantially its entire area, to provide support to the sheet of ceramic. The ceramic sheet is formed separately from the perforated planar sheet, rather than being formed by deposition onto it.

To obtain greater power output it is well-known to arrange multiple cells in a stack. However there can be problems with such a stack, for example due to changes in volume of electrode components during operation.

According to the present invention there is provided a rechargeable electrochemical cell comprising two electrode compartments, one being an anode compartment and the other being a cathode compartment, the electrode compartments being enclosed in part by metal plates that define end faces of the cell, the two compartments being separated by an impermeable, ion-conducting electrolyte element, the cell being a molten sodium/metal chloride cell, the electrolyte element being a sodium-ion-conducting ceramic; and the cathode compartment in its uncharged state containing a cathodic mixture comprising metal powder, sodium chloride, and sodium aluminium chloride (sodium tetrachloroaluminate, NaAlCl₄), and wherein the end face of the plate enclosing the cathode compartment has a central region that is slightly concave prior to operation, surrounded by a flat peripheral rim.

The metal powder in the cathodic mixture may be nickel or iron.

Prior to operation the cell is uncharged and at ambient temperature. In order for the cell to function the cell is warmed to above the melting point of the NaAlCl₄, for example to 180° C. As a result of the change of temperature and the phase change, the volume of the cathodic mixture increases. This volume increase is accommodated by a change in the curvature of the central region of the end face, without any change in the overall thickness of the cell. Clearly the metal plate that defines the slightly concave end face must be sufficiently flexible to change its shape in this way. The concave face may have a uniform curvature, or may have a curved margin and a substantially flat base to the recess.

In the manufacture of the cell, the cathodic mixture may first be pre-formed into a free-standing structure (referred to as a “biscuit”). For example, a powder mixture containing nickel powder, sodium chloride, and aluminium powder and preferably also a small proportion other ingredients such as iron sulphide, sodium iodide and sodium fluoride, may be introduced into a mould, compacted, and then infiltrated with molten sodium aluminium chloride (NaAlCl₄), preferably under vacuum. When cooled to room temperature the resulting biscuit is strong enough to be handled, and can be assembled with the other cell components.

The cell is thus a modified ZEBRA cell, such that the anode compartment of the cell when charged contains sodium metal.

The cell has a ceramic sheet as its electrolyte, to separate the anode compartment from the cathode compartment. The cell may also comprise, preferably in the anode compartment, a perforated sheet of metal adjacent to the sheet of ceramic, to provide support to the sheet of ceramic, the ceramic sheet either being formed by deposition as a layer onto the perforated metal sheet, or alternatively being formed separately from the perforated planar sheet. The ceramic electrolyte sheet must be non-permeable to gases or liquids, although it is a conductor of the sodium ions that must pass between the anode and cathode compartments during operation.

The anode compartment may also comprise a carbon felt, preferably highly porous, for example of long carbon fibres, to assist in the transfer of sodium metal away from or towards the sheet of ceramic, during charging and discharging of the cell. The carbon felt is highly porous, and preferably graphitic; it may be a paper-like sheet of initial thickness about 1.5 mm, and may for example have an area density of less than 200 g/m², for example 100 g/m².

The provision of a perforated metal plate or a carbon felt adjacent to the anodic face of the ceramic electrolyte, these being electrically connected to the anode plate, enables sodium metal to be formed at that face of the electrolyte during charging of the cell, and sodium to ionise at that face during discharge. As an alternative, the surface of the ceramic electrolyte may be coated, on the surface facing the anode compartment, with an electronically conductive coating. Such a coating may be of graphite, or of a polyphosphate glass containing particles of electronically conductive material. The polyphosphate glass is a sodium-ion conductor. The particles may be carbon powder, tin powder, and/or aluminium flake or powder.

The metal plate enclosing the anodic compartment may also define a slightly concave end face, as initially assembled and prior to operation, i.e. when the cell is uncharged and at ambient temperature, so it doesn't bulge when the compartment fills with molten sodium when charged. It is desirable to assemble the cell under vacuum, rather than in an inert atmosphere, as this ensures there is no gas to cause pressure in the anode compartment during operation.

The metal of which the metal sheet is formed is “inert” in the sense that it does not react chemically with components of the cell with which it is in contact during use; it may for example be a metal such as nickel, or aluminium-bearing ferritic steel (such as the type known as Fecralloy™, or a steel that forms an electronically-conductive and adherent scale, for example a CrMn oxide scale, when heated in air. The sheet may be of thickness no more than 3.0 mm, or no more than 1.0 mm, or no more than 0.5 mm, for example 0.1 mm or 0.2 mm. If it is next to the ceramic electrolyte it must be perforated so it has a very large number of through holes. If it is separate from the ceramic electrolyte, it need not be perforated; and it may be of another type of steel, such as stainless steel.

The perforated sheet may have a margin around its periphery that is not perforated; this margin may make it easier to seal the periphery of the perforated plate to adjacent components of the cell. This margin may be of width no more than 15 mm, for example 10 mm or 5 mm or 3 mm. The perforated sheet is preferably in the anode compartment, where it will help wick the molten sodium towards the surface of the ceramic sheet. The edge of the perforated sheet may be welded to a lip of an adjacent cell component, for example a plate that forms the anode compartment.

The metal plates that enclose in part the anode compartment and the cathode compartment are also of inert metal, in the sense that they do not react with the contents of the respective compartments during use. They may be of stainless steel, or the metals mentioned above as suitable for the perforated sheet.

Such a cell operates at an elevated temperature. A conventional sodium/nickel chloride cell, or ZEBRA cell, operates at 280° C. or 300° C. The operating temperature depends in part on the nature of the electrolyte and its ionic conductivity; a cell with a thin layer of ceramic as the electrolyte may have a lower operating temperature, for example in the range 175° C. to 225° C. In any event the sealing between the cell components must remain tight at the elevated temperature of operation. The sealing may utilise a high-temperature polymer such as PTFE, or an inorganic material of an electrical insulator, such as mica or vermiculite. The seal of the anode compartment may use a carbon-based gasket, or indeed the anode plate may be welded to the periphery of the perforated sheet, if the ceramic is deposited on the perforated sheet. The high-temperature polymers are preferably not used to seal the anode compartment, as they may interact with the molten sodium.

As a further option, the flat peripheral rim around the central region of the plate enclosing the cathode compartment may define at least one projection or recess and the end face of the plate enclosing the anode compartment define at least one mating recess or projection, so when a plurality of such cells are stacked together the mating projections and recesses of the end faces of adjacent cells engage with each other to hold the cells in alignment.

The interlocking or engaging projections and recesses, or dimples and recesses, also ensure good electrical connection between successive cells in the stack. Preferably the projections and recesses are provided at or adjacent to each corner of a polygonal cell, for example a square cell.

The invention will now be further and more particularly described, by way of example only, and with reference to the accompanying drawings in which:

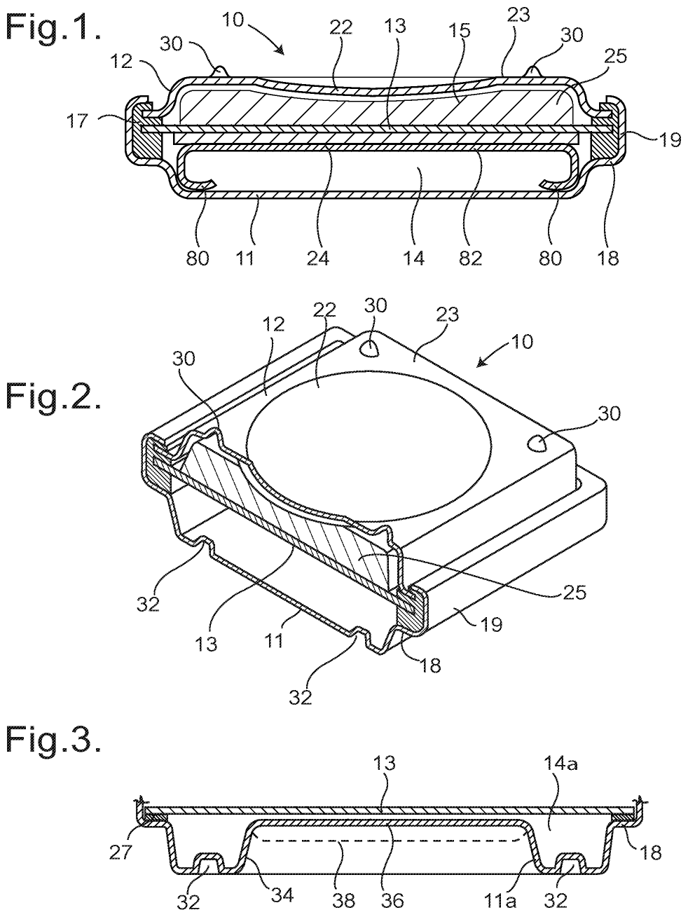

FIG. 1 shows a cross-sectional view through an electrical cell of the invention;

FIG. 2 shows a perspective view, partly broken away, of the cell of FIG. 1; and

FIG. 3 shows a cross-sectional view of a modification to the cell of FIG. 1, only the anode compartment being shown.

Referring to FIG. 1, this shows a cell 10 of the present invention. The cell 10 operates at an elevated temperature, and comprises dish-shaped metal electrode plates 11 and 12 each defining a flat peripheral rim, between which is an impermeable sodium-ion-conducting electrolyte sheet 13. The anode electrolyte plate 11 has a flat peripheral rim 18 which is slightly wider than the rim of the cathode electrode plate 12, from which a short sleeve portion 19 extends upward (as shown). The cell 10 is square in plan view. The electrode plates 11 and 12, together with the electrolyte sheet 13, define an anode compartment 14 on one side of the electrolyte sheet 13 and a cathode compartment 15 on the other side of the electrolyte sheet 13, which contain chemicals that interact as a consequence of the passage of ions through the electrolyte sheet 13 to generate electricity. Around their periphery the rims of the electrode plates 11 and 12 are sealed to the sheet of electrolyte 13 by a heat-resistant electrically-insulating sealant 17. In this example the cell components are held together by crimping the upstanding edge of the sleeve portion 19 around the edges of the electrolyte sheet 13 and the electrode plate 12, all of which are separated by the insulating sealant 17; this sealing and crimping arrangement is represented diagrammatically.

The cell 10 is a sodium/nickel chloride cell. The electrode plates 11 and 12 may be of stainless steel. In its charged state the cell 10 would contain sodium metal in the anode compartment 14 and nickel chloride in the cathode compartment 15. However, the cell would typically be assembled in a completely discharged state, the cathode compartment 15 being initially filled with a powder mixture containing nickel powder, sodium chloride, and sodium aluminium chloride (sodium tetrachloroaluminate, NaAlCl₄) and preferably also a small proportion other ingredients such as iron sulphide, sodium iodide and sodium fluoride, and aluminium powder.

In particular, for ease of assembly, the powder mixture including nickel powder and sodium chloride, but without the sodium aluminium chloride, would be placed in a mould, and compressed; the compressed powder mixture is then infiltrated with molten sodium aluminium chloride under vacuum, and then cooled, to form a coherent biscuit 25. This biscuit 25 is placed in the cathode compartment 15, occupying most of the space; a layer of carbon felt (not shown) may be placed above the biscuit 25, between the biscuit 25 and the cathode plate 12.

The impermeable sodium-ion-conducting electrolyte sheet 13 may be of NaSICON. A perforated metal sheet 24 is adjacent to the electrolyte sheet 13, but spaced apart from it by a layer of carbon felt 82. The perforated metal sheet 24 provides mechanical support to the electrolyte sheet 13. Along two opposite sides, peripheral portions of the perforated metal sheet 24 are curved in to form springs 80 which contact the inner face of the anode plate 11 in the assembled cell 10, so those springs 80 push the perforated metal sheet 24 resiliently towards the electrolyte sheet 13. The carbon felt 82 is readily wetted by molten sodium, so it helps to wick molten sodium towards or away from the face of the electrolyte sheet 13.

For the cell 10 to operate, it must first be heated to a temperature above 157° C., such as 200° C., at which the sodium aluminium chloride is molten, and at such a temperature the non-permeable ceramic electrolyte sheet 13 will conduct sodium ions sufficiently. The molten sodium aluminium chloride enables sodium ions to diffuse between the sodium chloride and the electrolyte sheet 13. The cell can therefore be charged by applying a voltage from an external power supply between the two electrode plates 11 and 12, so sodium ions pass through the electrolyte sheet 13 into contact with the carbon felt 82 in the anode space 14, where sodium metal is formed, while within the cathode space 15 the remaining chloride ions react with the nickel to form nickel chloride. The cell 10 is readily reversible, so it can be charged and discharged multiple times.

The perforated metal sheet 24 which provides support to the electrolyte sheet 13 may be of a metal such as nickel, or aluminium-bearing ferritic steel (such as the type known as Fecralloy™), or a steel that forms an electrically-conductive and adherent scale, for example a CrMn oxide scale, when heated in air. Most of the sheet 24 is perforated to produce a very large number of through holes, but the peripheral portions that form the springs 80 do not require perforations.

The plate 12 has a central circular region 22 which is depressed so it forms a slightly concave outer face as the cell is initially assembled and prior to operation, that is to say when the cell is uncharged and at ambient temperature. The central region 22 is surrounded by a substantially flat rim 23. When the cell 10 is heated to its operating temperature, the increase of volume of the materials in the cathodic compartment 15 is accommodated by the concave surface of the central region 22 becoming flatter. This doesn't alter the thickness of the cell 10.

Referring also to FIG. 2, which shows a perspective view of the cell 10 with an edge portion broken away, the plate 12 also defines a protrusion or bump 30 near each corner of the cell 10; the plate 11 defines recesses 32 in the directly opposite positions. The bumps 30 and the recesses 32 are of complementary shapes. Consequently when two or more cells 10 are assembled into a stack, the bumps 30 of each cell 10 mate with the recesses 32 of the adjacent cell 10. Not only do the bumps 30 and the recesses 32 ensure the cells 10 remain correctly aligned, but the regions of the plates 12 and 11 that define the bumps 30 and the recesses 32 are also stiff enough to ensure good electrical connection between successive cells in the stack, despite changes in temperature of the cells 10, and changes in the state of charge of the cells 10.

The carbon felt 82 and the perforated metal sheet 24 are not shown in FIG. 2 for clarity.

As an alternative, instead of providing the electrolyte in the form of the discrete sheet 13 of ceramic, the electrolyte may instead be in the form of one or more layers of ceramic deposited onto a perforated metal sheet. The metal sheet may be substantially equivalent to the metal sheet 24, but without the curved springs 80, so it is planar. Preferably a porous and permeable layer of ceramic would first be deposited and bonded to the metal sheet, and then an impermeable layer of sodium-ion-conducting ceramic deposited and bonded to the porous layer, completely covering the porous layer. The ceramic layers would cover all the perforations through the perforated metal sheet, but the edges of the sheet would not be perforated. The edges may be in electrical contact with the anode plate 11, for example they may rest on the peripheral rim 18, to which they may be welded to provide a seal, or they may be sealed to the rim 18 by a conductive gasket. Electrical contact may also be provided by carbon felt within the anode compartment 14.

As explained in the following paragraphs, in some cases one or both of the carbon felt 82 and the perforated metal sheet 24 may be omitted.

As another alternative, the edges of the carbon felt 82 and the ceramic electrolyte sheet 13 may rest directly on the peripheral rim 18 of the anode plate 11. In this case the perforated metal sheet 24 may be omitted; a central part of the anode plate 11 may be depressed to form a concave outer face analogous to the region 22 of the cathode plate 12. In the cell as initially assembled there is no sodium in the anode compartment 14. During charging, molten sodium is formed at the anodic face of the electrolyte sheet 13, and moves throughout the anodic compartment 14 by capillarity through the carbon felt 82.

Referring now to FIG. 3, which shows only the anode compartment 14a of a cell 10a which is an alternative modification to the cell 10; those components that differ from those of the cell 10 are indicated by the same reference numerals followed by ‘a’. In this cell 10a, the anodic face of the ceramic electrolyte sheet 13 is pre-treated before assembly, for example with a coating of graphite, so it is electronically conductive. The edges of the electrolyte sheet 13 are sealed to the peripheral rim 18 of the anode plate 11a by a conductive gasket 27, which may be carbon-based. The carbon felt 82 may therefore be omitted; and the perforated metal sheet 24 is also omitted. The anode plate 11a defines recesses 32 adjacent to each corner, but the central part of the plate 11a is concave, defining a curved rim 34 and a flat depressed region 36, which is shown in its initial form as the cell 10a is assembled; in this state there is a narrow gap between the electrolyte sheet 13 and the flat depressed region 36 of the plate 11a. During charging of the cell 10a, sodium is formed at the anodic face of the electrolyte sheet 13. Capillarity in the narrow gap between the face of the electrolyte sheet 13 and the depressed region 36 of the anode plate 11a distributes molten sodium through the compartment 14a. As indicated by the broken line 38, as the sodium fills the compartment 14a the depressed region 36 moves away from the electrolyte sheet 13, increasing the available volume in the compartment 14a.

Rather than coating the surface of the ceramic electrolyte sheet 13 with graphite, other materials may be used for this purpose. For example the anodic surface of the ceramic electrolyte sheet 13 may be painted with an aqueous solution of sodium polyphosphate containing carbon powder, tin powder, and/or aluminium flake or powder, and then dried and baked. The sodium polyphosphate forms a sodium-ion-conducting glass, and the metal or carbon particles allow electronic conduction. Other options are to coat or paint the surface with lead acetate in aqueous solution, or tin (II) chloride in solution in ethanol, the surface then being dried and baked; the baking is performed in an oxygen-free atmosphere to produce a mixture of Pb(IV) oxide and Pb metal, or Sn(IV) oxide/chloride and Sn metal, all of which are conductive. The resulting small particles of metal and metal oxides or metal chlorides on the surface allow electronic conduction.

It will be appreciated that the cell 10 may be modified by utilising a cathode plate 12 modified to have a concave outer face like that of the anode plate 11a shown in FIG. 3, defining a curved rim and a depressed portion like the rim 34 and the depressed portion 36. In the cell with this modification, as initially assembled, the depressed portion may press directly against the surface of the biscuit 25.

1. A rechargeable electrochemical cell comprising two electrode compartments, one being an anode compartment and the other being a cathode compartment, the electrode compartments being enclosed in part by metal plates that define end faces of the cell, the two compartments being separated by an impermeable, ion-conducting electrolyte element, the cell being a molten sodium/metal chloride cell, the electrolyte element being a sodium-ion-conducting ceramic; and the cathode compartment in its uncharged state containing a cathodic mixture comprising metal powder, sodium chloride, and sodium aluminium chloride (sodium tetrachloroaluminate, NaAlCl₄), and wherein the end face of the plate enclosing the cathode compartment has a central region that is slightly concave prior to operation of the cell, surrounded by a flat peripheral rim, the central region of the end face being sufficiently flexible that when during operation the volume of the cathodic mixture increases, this volume increase is accommodated by a change in the curvature of the central region.

2. A cell as claimed in claim 1 wherein the flat peripheral rim around the central region of the plate enclosing the cathode compartment defines at least one projection or recess and the end face of the plate enclosing the anode compartment defines at least one mating recess or projection, so when a plurality of such cells are stacked together the mating projections and recesses of the end faces of adjacent cells engage with each other to hold the cells in alignment.

3. A cell as claimed in claim 2 which has generally square end faces, wherein the projections and recesses are provided at each corner of the square cell.

4. A cell as claimed in any claim 1 wherein the metal powder in the cathodic mixture is of nickel or iron.

5. A cell as claimed in claim 1 wherein the cell also comprises a perforated sheet of metal arranged to provide support to the impermeable electrolyte element.

6. A cell as claimed in claim 5 wherein the impermeable electrolyte element is spaced apart from the perforated metal sheet by a layer of carbon felt.

7. A cell as claimed in claim 1 wherein the electrolyte element is coated, on the surface facing the anode compartment, with an electronically conductive coating.

8. A cell as claimed in claim 7 wherein the coating is of a polyphosphate glass containing particles of electronically conductive material.

9. A cell as claimed in claim 8 wherein the particles are carbon powder, tin powder, and/or aluminium flake or powder.

10. A cell as claimed in claim 1 wherein the metal plates that enclose in part the anode compartment and the cathode compartment are of a metal that does not react with the contents of the respective compartments during use, being of stainless steel, or nickel, or aluminium-bearing ferritic steel, or a steel that forms an electrically-conductive and adherent scale, for example a CrMn oxide scale, when heated in air.

11. A cell as claimed in claim 1 wherein the concave central region is of uniform curvature.

12. A cell as claimed in claim 1 wherein the concave central region defines a curved margin and a substantially flat base.

13. A cell as claimed in claim 1 wherein the anodic metal plate enclosing the anodic compartment defines a slightly concave end face, as initially assembled and prior to operation with the cell uncharged and at ambient temperature.

14. A cell as claimed in claim 1 wherein a central part of the anodic plate enclosing the anodic compartment is concave, defining a curved rim and a flat depressed region, arranged such that in the cell as initially assembled and uncharged there is a narrow gap between the electrolyte sheet and the flat depressed region of the anodic plate, the gap being sufficiently narrow that, during charging of the cell, capillarity in the narrow gap between the face of the electrolyte sheet and the depressed region of the anodic plate distributes molten sodium through the anodic compartment.

15. A cell as claimed in claim 14 wherein the central part of the anodic plate is flexible such that during charging, as sodium fills the anode compartment, the depressed region moves away from the electrolyte sheet, increasing the available volume in the anodic compartment.
